(19) United States
(12) Patent Application Publication
(10) Pub. No.: US 2008/0143933 A1
(43) Pub. Date: Jun. 19, 2008

(54) OPTICALLY COMPENSATED BEND MODE LIQUID CRYSTAL DISPLAY DEVICES AND FABRICATION METHODS THEREOF

(75) Inventors: Yi-An Sha, Taipei City (TW); Cheng Hsi Hsieh, Kaohsiung City (TW); Wei-Yuan Cheng, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/845,582

(22) Filed: Aug. 27, 2007

(30) Foreign Application Priority Data
Dec. 14, 2006 (TW) TW95146839

(51) Int. Cl. G02F 1/1337; G02F 1/1335; H01J 9/20

(52) U.S. Cl. 349/106; 349/128; 445/58

(57) ABSTRACT

The invention relates to optically compensated bend (OCB) mode liquid crystal display devices and fabrication methods thereof. The OCB mode liquid crystal display includes a first substrate, a second substrate and a liquid crystal layer interposed therebetween. A first alignment layer is disposed on the first substrate, and a second alignment layer is disposed on a second region of the first substrate exposing the first alignment layer on a first region. A third alignment is disposed on the second substrate. Alignment orientations of liquid crystal molecules on the first and second alignment layers are different. When an appropriate voltage is applied to the OCB mode liquid crystal display, a splay to bend transition boundary is formed between the first and the second regions.

### BACKGROUND OF THE INVENTION

1. Field of the Invention

The invention relates to display devices, and more particularly to optically compensated bend mode liquid crystal display (OCB-LCD) devices capable of achieving high-speed response time and wide viewing angles and fabrication methods thereof.

2. Description of the Related Art

Liquid crystal display (LCD) devices have several advantages over other display technologies, such as a smaller volume, a lighter weight, and lower power consumption. As such, LCD devices are being applied in a variety of electronic and communication devices including notebook computers, personal digital assistants (PDA), mobile phones and others. Given the trends, technological development of LCD device are now focusing on lighter and thinner profiles with increased portability.

However, for conventional LCD devices, due to a narrow viewing angle applications have been limited. To improve the viewing angle of LCD devices, multi-domain vertical alignment (MVA) LCD devices comprising of bumps or protrusions on substrate for creating different orientations of liquid crystal molecules have been introduced. Nonetheless, different liquid crystal orientations can cause electric field changes in a single liquid crystal cell, changes in liquid crystal alignment and changes in liquid crystal relaxation. In addition, forming bumps or protrusions on substrate requires a complex lithographic process utilizing a half-tone mask.

Another conventional method for improving the viewing angle of LCD devices is provided by changing orientations of liquid quid crystal molecules to achieve self-compensated viewing angles. This method improves response speed and widens viewing angles of LCD devices.

U.S. Pat. No. 6,950,172, the entirety of which is hereby incorporated by reference, discloses an optically compensated bend mode liquid crystal display (OCB-LCD) device. The OCB-LCD device is divided into multiple aligned domain regions and driven by an appropriate method to achieve a splay-to-bend mode transition boundary within a pixel region. Note that multiple aligned domain regions are conventionally formed by UV light illuminating on a photo-catalyst contained alignment layer. Alignment layer formed by photo-illumination requires multiple photo-mask processes and process of placing a photo-catalyst into the alignment layer, causing fabrication complexity.

FIG. 1A is a cross section of a conventional OCB-LCD device divided into multiple aligned domain regions and driven by an appropriate method to achieve a splay-to-bend mode transition boundary. FIG. 1B is a plan view of the conventional OCB-LCD device with a splay-to-bend mode transition boundary of FIG. 1A. Referring to FIG. 1A, an OCB-LCD device 100 includes an active matrix array of liquid crystal cell 104 disposed between an upper polarizer 101 and a lower polarizer 102. A phase compensated film 103 is interposed between the upper polarizer 101 and the liquid crystal cell 104. The active matrix array of liquid crystal cell 104 includes an active matrix array substrate 106 and an opposite substrate 105. A pixel electrode 108 is disposed on the active matrix array substrate 106. A lower alignment layer 110 is disposed on the pixel electrode 108. A common electrode 107 is disposed on the opposite substrate 105. An upper alignment layer 109 is disposed on the common electrode 107. A liquid crystal layer 112 is interposed between the active matrix array substrate 106 and the opposite substrate 105.

The conventional OCB-LCD device 100 includes an array of pixel regions. Each pixel region is enclosed by data lines 113 and gate lines 114 as indicated in FIG. 1B. Each pixel region is configured with a switching element 111 to control the pixel electrode of the pixel region. Furthermore, each pixel region is divided into sub-pixel regions I and II. In sub-pixel region I, liquid crystal molecules have a small pre-tilt angle A2 at the lower alignment layer 110b and a large pre-tilt angle C2 at the upper alignment layer 109b. Conversely, in the sub-pixel region II, liquid crystal molecules have a large pre-tilt angle B2 at the lower alignment layer 110a and a small pre-tilt angle D2 at the upper alignment layer 109a.

When the conventional OCB-LCD device 100 is driven by appropriate procedure, liquid crystal molecules 120 and 121 exhibit splay-to-bend transition, thus creating a disclination line 123 between the sub-pixel regions I and II. The disclination line 123 is generated from a nucleus (indicated as 124 of FIG. 1B) gradually growing outwardly.

The conventional OCB-LCD device 100 however, requires adding a photo-catalyst or photo activator in the alignment layer, thus requiring expensive and intricate UV-light exposure machinery and equipment. Moreover, multiple photo-mask processes are also required, thus further increasing production costs.

### BRIEF SUMMARY OF THE INVENTION

A detailed description is given in the following embodiments with reference to the accompanying drawings.

Embodiments of the invention provide an optically compensated bend mode liquid crystal display (OCB-LCD) device capable of achieving high-speed response time and wide viewing angles. By forming a protrusion structure and/or slit electrode structure in each pixel of the display device, multi-domains with different liquid crystal orientations are formed.

An exemplary embodiment of the invention provides an optically compensated bend (OCB) mode liquid crystal display (LCD) device, comprising a first substrate opposite a second substrate with a layer of liquid crystal molecules interposed therebetween. A first alignment layer is disposed on the first substrate. A second alignment layer is selectively disposed on a second region of the first alignment layer, exposing a first region of the first alignment layer. A third alignment layer is disposed on the second substrate. Orientations of liquid crystal molecules on the first alignment layer and on the second alignment layer are different. When a voltage is applied to the OCB mode LCD device, a dual mode transition boundary is created between the first region and the second region.

Another exemplary embodiment of the invention provides an OCB mode LCD device, comprising a first substrate opposite a second substrate with a layer of liquid crystal molecules interposed therebetween. A first alignment layer is disposed on the first substrate. A second alignment layer is selectively disposed on a second region of the first alignment layer, exposing a first region of the first alignment layer. A third alignment layer is disposed on the second substrate. A fourth alignment layer is selectively disposed on a second region of the third alignment layer, exposing a first region of the third alignment layer. Orientations of liquid crystal molecules on the first alignment layer and on the second alignment layer are different, and orientations of liquid crystal molecules on the third alignment layer and on the fourth alignment layer are different. When a voltage is applied to the OCB mode LCD device, a dual mode transition boundary is created between the first region and the second region.

The invention also provides a method for fabricating an OCB mode LCD device. A first substrate with an electrode structure thereon is provided. A first alignment layer is applied on the first substrate. A second alignment layer is printed on the second region of the first alignment layer, exposing a first region of the first alignment layer. A third alignment layer is applied on a second substrate. The first substrate and the second substrate are opposed. A layer of liquid crystal molecules is injected between the first substrate and the second substrate. Orientations of liquid crystal molecules on the first alignment layer and on the second alignment layer are different. When a voltage is applied to the OCB mode LCD device, a dual mode transition boundary is created between the first region and the second region.

### BRIEF DESCRIPTION OF THE DRAWINGS

The invention can be more fully understood by reading the subsequent detailed description and examples with references made to the accompanying drawings, wherein:

FIG. 1A is a cross section of a conventional OCB-LCD device divided into multiple aligned domain regions and driven by an appropriate method to achieve a splay-to-bend mode transition boundary;

FIG. 1B is a plan view of the conventional OCB-LCD device with a splay-to-bend mode transition boundary of FIG. 1A;

FIG. 2 is schematic view of applying an alignment layer on a substrate according to an embodiment of the invention;

FIG. 3 is a plan view illustrating the patterned alignment layer on a substrate formed by the step as shown in FIG. 2;

FIG. 4 is a cross section of forming a second alignment layer on the first patterned alignment layer according to an embodiment of the invention;

FIG. 5 is a cross section of a second patterned alignment layer on the first patterned alignment layer according to an embodiment of the invention;

FIG. 6A is a cross section of a first embodiment of a multiple aligned domain OCB-LCD device including the substrate of FIG. 5;

FIG. 6B is a cross section of a second embodiment of a multiple aligned domain OCB-LCD device of the invention;

FIG. 6C is a cross section of a third embodiment of a multiple aligned domain OCB-LCD device of the invention;

FIG. 6D is a cross section of a fourth embodiment of a multiple aligned domain OCB-LCD device of the invention; and

FIG. 6E is a cross section of a fifth embodiment of a multiple aligned domain OCB-LCD device of the invention.

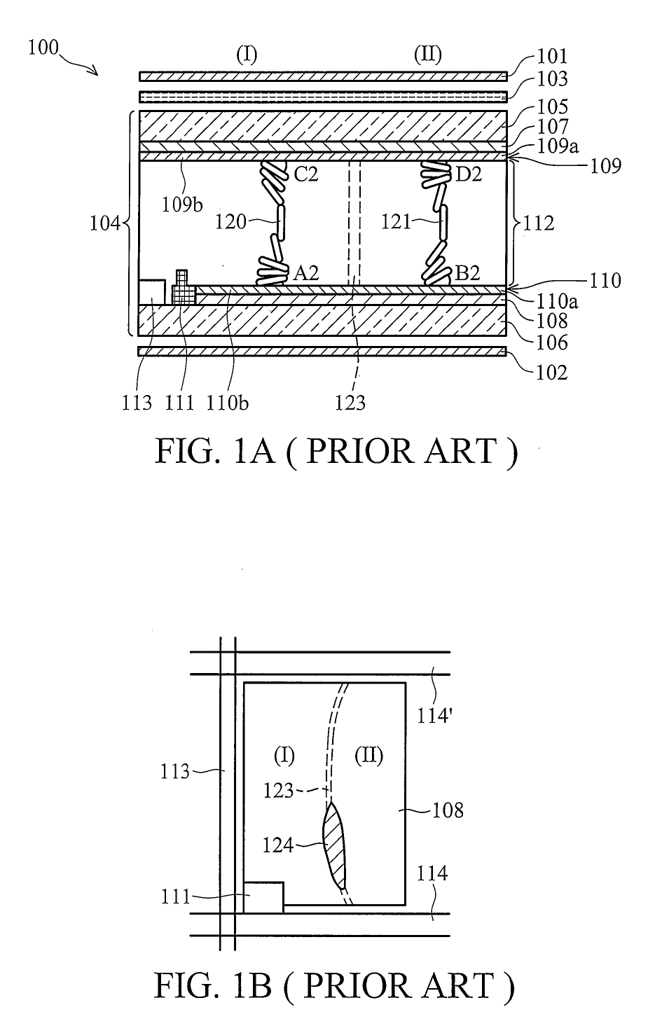

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Some exemplary embodiments of the invention provide a multiple aligned domain OCB-LCD device. Applying alignment layers with different surface characteristics in each pixel regions can achieve wide viewing angles of the OCB-LCD device. Note that although some embodiments are described in conjunction with examples of an OCB mode LCD, the features of these embodiments may also be applied to other mode LCD devices with multiple aligned domains.

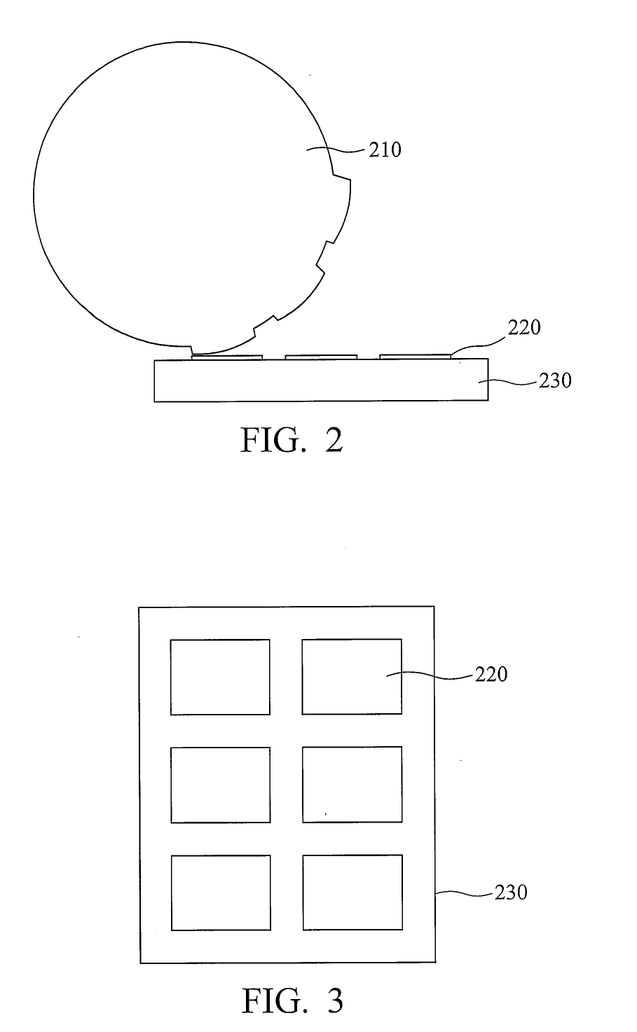

FIG. 2 is schematic view of applying an alignment layer on a substrate according to an embodiment of the invention. The alignment layer may comprise polyvinyl alcohol (PVA), polyimide (PI), polyamide (PA), polyurethane (PU), nylon, silicon, or lecithin. The alignment layer is preferably applied by a roller to a large scale substrate.

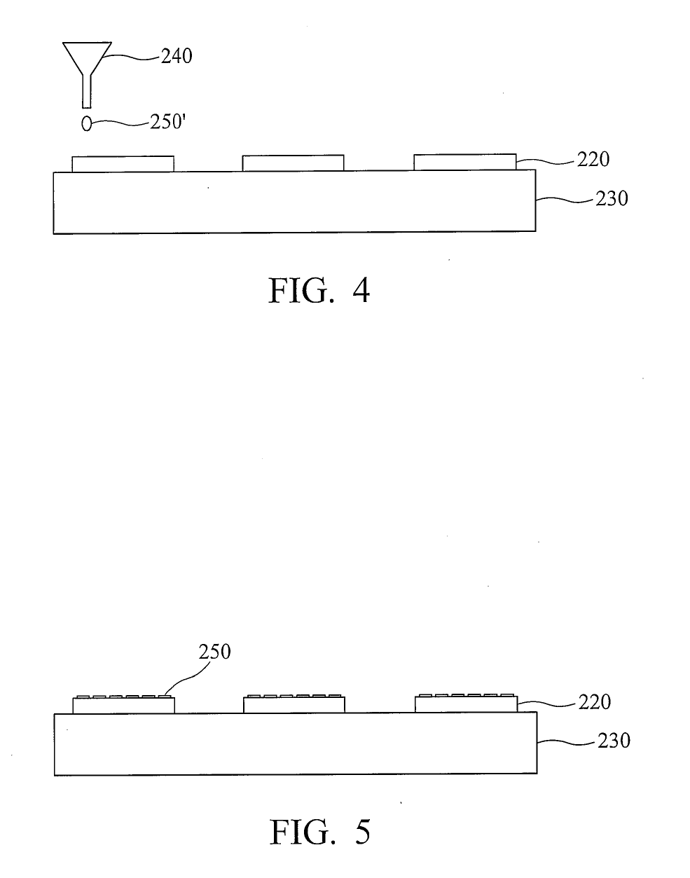

Referring to FIG. 3, a substrate 230 with an electrode layer or other elements such as color filters (not shown) is provided. The substrate 230 comprises a glass substrate, metal substrate, or a plastic substrate. The substrate 230 further comprises an array of active control devices including thin film transistors (TFTs). The electrode comprises organic conductive material or inorganic conductive material. Alternatively, the substrate 230 can be an opposing substrate with a color filter layer thereon. Referring to FIG. 2, sequentially, a relief (or anastatic) printing plate with predetermined patterns is attached on a roller 210. A first patterned alignment layer 220 is preferably applied by the roller 210 to a large scale substrate 230.

Note that the first patterned alignment layer 220 of FIG. 3 is not limited to representing the entire display region of an LCD device. The first patterned alignment layer 220 may represent only a single pixel region or a plurality of pixel regions.

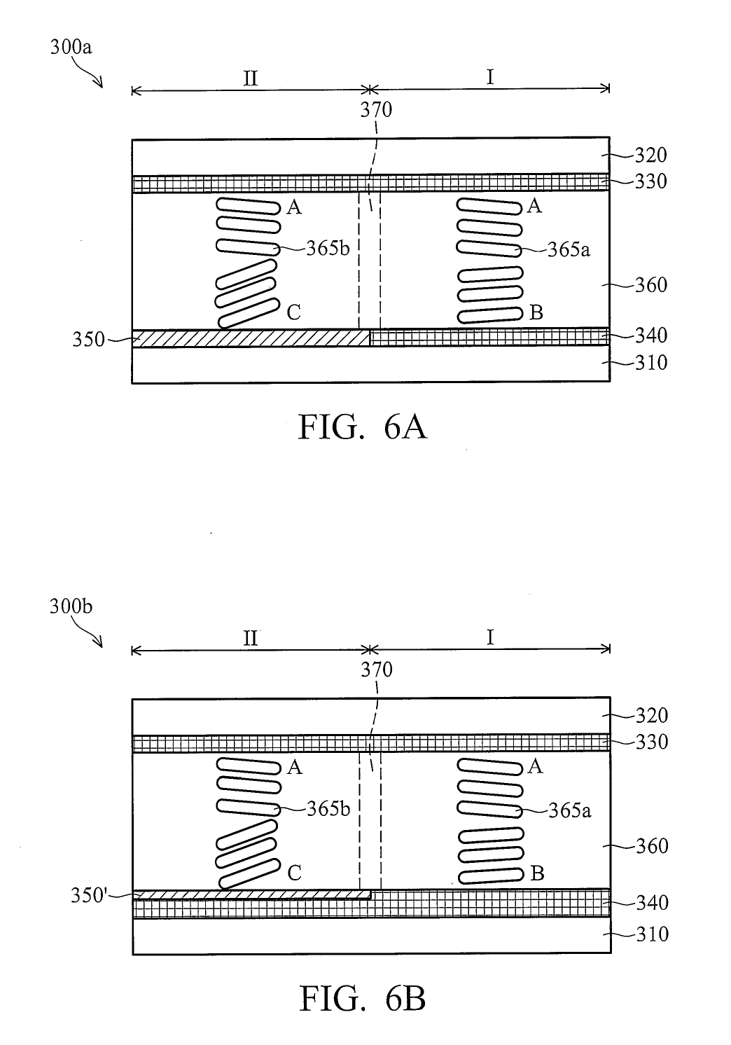

FIG. 4 is a cross section of forming a second alignment layer on the first patterned alignment layer according to an embodiment of the invention. Referring to FIG. 4, a second alignment layer 250 is preferably applied on the first patterned alignment layer 220 by inkjet printing. For example, a fluid injector device 240, such as a thermal bubble driven inkjet print head or a piezoelectric diaphragm driven inkjet print head, can inject droplets 250′ of alignment material on the first alignment layer 220. The location and dimensions of the second alignment layer 250 can be achieved by controlling the position of the fluid injector device 240 and the volume of the droplet 250′. The second alignment layer may comprise polyvinyl alcohol (PVA), polyimide (PI), polyamide (PA), polyurethane (PU), nylon, silicon, or lecithin. An aligning procedure such as rubbing is subsequently performed after a 180° C. baking procedure.

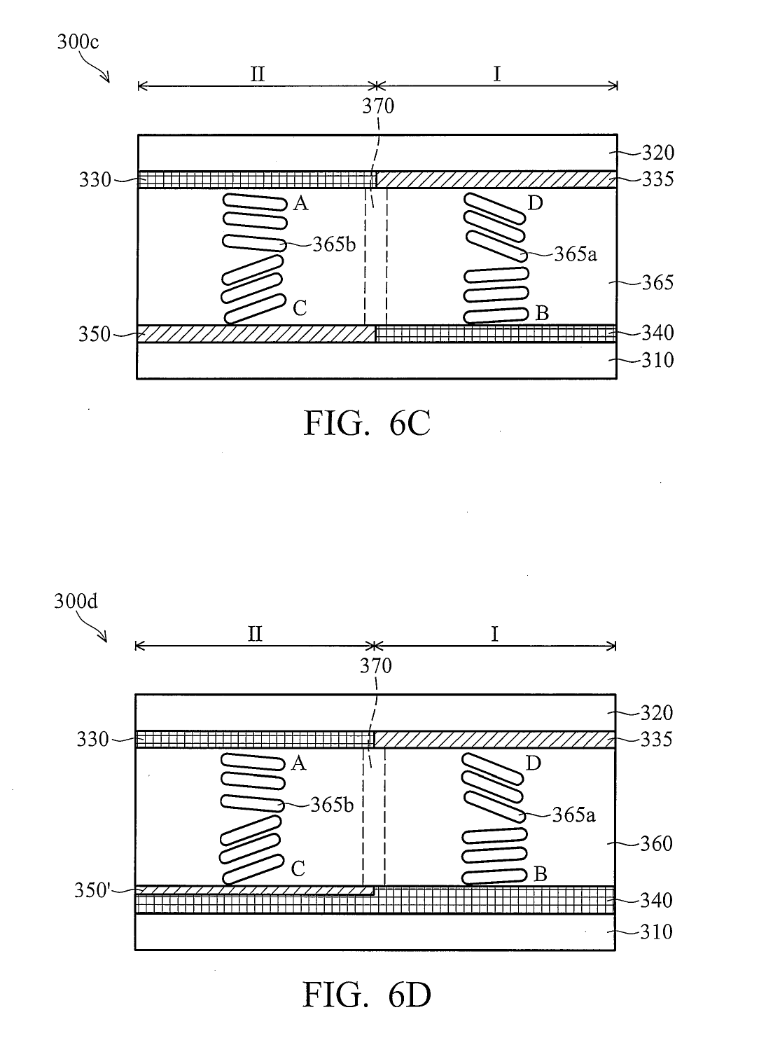

FIG. 5 is a cross section of a second patterned alignment layer on the first patterned alignment layer according to an embodiment of the invention. In FIG. 5, the second alignment material 250 is precisely printed at predetermined sites on the first alignment layer 220, exposing part of the first alignment layer 220. By selecting different materials for the first and the second alignment layers, different liquid crystal (LC) orientations can be achieved in a single LCD device, thereby widening the viewing angle.

The first and the second alignment layers can be selected from materials with different polarities, as different polarities can cause different LC orientations due to surface tensions between the alignment layers and the LC layer.

According to an exemplary embodiment of the invention, the first alignment layer 220 preferably provides a vertical liquid crystal molecule orientation, i.e., a longitudinal axis of the liquid crystal molecule is pre-tilted 75°-90° against the first alignment layer 220, while the second alignment layer 250 provides a horizontal liquid crystal molecule orientation, i.e., a longitudinal axis of the liquid crystal molecule is pre-tilted 0°-15° against the second alignment layer 250. Alternatively, the first alignment layer 220 provides a horizontal liquid crystal molecule orientation, i.e., a longitudinal axis of the liquid crystal molecule is pre-tilted 0°-15° against the first alignment layer 220, while the second alignment layer 250 provides a vertical liquid crystal molecule orientation, i.e., a longitudinal axis of the liquid crystal molecule is pre-tilted 75°-90° degrees against the second alignment layer 250.

The multiple aligned domain OCB-LCD devices of some embodiments of the invention are achieved by inkjet printing or rolling polyimide (PI) in conjunction with inkjet printing. The different alignment interfaces cause a disclination line between liquid crystal molecules in each sub-pixel region. Moreover, when the OCB-LCD device is driven by appropriate procedure, the disclination line becomes nucleation sites of splay-to-bend transition, thereby increasing viewing angles and accelerating phase transition speed.

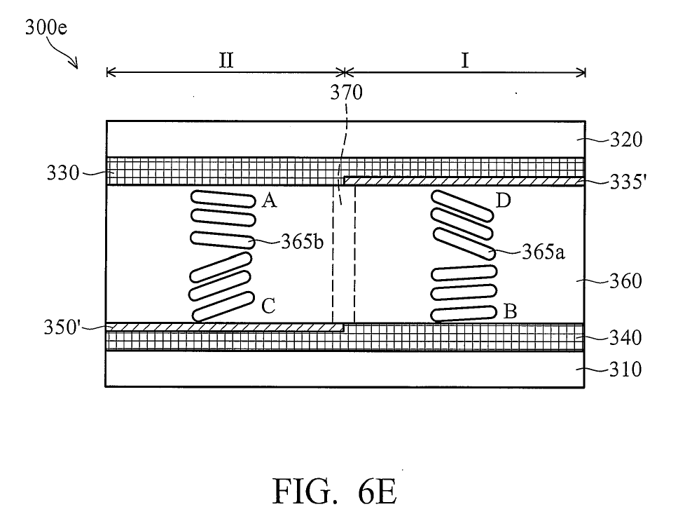

FIG. 6A is a cross section of a first embodiment of a multiple aligned domain OCB-LCD device including a substrate of FIG. 5. Referring to FIG. 6A, an OCB-LCD device 300a comprises a first substrate 310, a second substrate 320 opposing the first substrate 310, and a liquid crystal layer 360 interposed between the first substrate 310 and the second substrate 320. The first substrate 310 can be for example an active matrix array substrate, while the second substrate 320 can be for example a color filter substrate. The color filter substrate can include a plurality of color filter structures disposed on the color filter substrate and a black matrix disposed among the plurality of color filter structures. The liquid crystal layer 360 comprises an OCB mode liquid crystal material which is less affected by liquid crystal liquidity, resulting in faster response speed.

An electrode layer is disposed on the first substrate 310 to serve as a pixel electrode controlling angled movement of liquid crystal molecules. A first alignment layer 340, such as commercial model SE-7492, is applied on a first region I of the first substrate 310. A bake process is then performed on the first substrate. A second alignment layer 350 is selectively disposed on a second region II of the first substrate 310. For example, the second alignment layer 350, such as commercial model SE-1410 diluted by γ-butylactone, is applied on a peripheral region of the first alignment layer (e.g., SE-7492). A baking process and a rubbing process are sequentially performed such that orientations of liquid crystal molecules on the first region I and on the second region II are different. Therefore, the first alignment layer 340 and the second alignment 350 separately provide the liquid crystal layer with different alignments and pre-tilt angles (as indicated as angle B and angle C). Angle B can be the same as or different from angle C. According to an exemplary embodiment of the invention, the first alignment 340 and the second alignment layer 350 can be separately formed by printing or inkjet printing on the first region I and the second region II of the first substrate 310. The first alignment 340 and the second alignment layer 350 can comprises polyvinyl alcohol (PVA), polyimide (PI), polyamide (PA), polyurethane (PU), nylon, silicon, or lecithin. Alternatively, the second alignment layer comprises an organic solvent, such as ethanol, isopropanol, n-methyl pyrrolidone, m-cresol, γ-butylactone, n,n-dimethylacetamide, n,n-dimethylformamide, ethylene glycol monobutyl ether, or diethylene glycol monoethyl ether.

The first region I of the first substrate 310 is a pixel region, while the second region II is a peripheral region. Alternatively, the first region I of the first substrate 310 is a peripheral region, while the second region is a pixel region. The peripheral region comprises a black matrix region, a gate line region, a data line region, an active device region, a contact hole region, and a slit region. Furthermore, according to another embodiment of the invention, the first region is a portion of a pixel region, while the second region is another portion of the pixel region.

The second substrate 320 includes a black matrix (BM) and a color filter structure thereon. An electrode is disposed on the color filter structure to serve as a common electrode controlling angled movement of liquid crystal molecules. A third alignment 330, such as commercial model SE-7492, is applied on the electrode. A baking process and a rubbing process are sequentially performed such that pre-tilt angles (indicated as angle A) of liquid crystal molecules on the third alignment layer is about 4°-5°. The third alignment 330 can comprises polyvinyl alcohol (PVA), polyimide (PI), polyamide (PA), polyurethane (PU), nylon, silicon, or lecithin.

According to an exemplary embodiment, the first alignment layer 340 can provide horizontal orientation to the liquid crystal layer 360 such that a longitudinal axis of the liquid crystal molecule is pre-tilted about 0°-15° (as indicated as angle B) against the first alignment layer 340. The second alignment layer 350 provides a vertical liquid crystal molecule orientation such that a longitudinal axis of the liquid crystal molecule is pre-tilted about 75°-90° (as indicated as angle B) against the second alignment layer. Furthermore, the third alignment layer 330 provides a horizontal liquid crystal molecule orientation such that a longitudinal axis of the liquid crystal molecule is pre-tilted about 0°-15° (as indicated as angle A) against the second alignment layer.

Alternatively, the first alignment layer 340 provides a horizontal liquid crystal molecule orientation such that a longitudinal axis of the liquid crystal molecule is pre-tilted 0°-10° against the first alignment layer 340. Conversely, the second alignment layer 350 provides a horizontal liquid crystal molecule orientation such that a longitudinal axis of the liquid crystal molecule is pre-tilted 0°-9° against the second alignment layer 350. Furthermore, the first alignment layer 340 can provide a horizontal liquid crystal molecule orientation such that a longitudinal axis of the liquid crystal molecule is pre-tilted 0°-7° against the first alignment layer. Conversely, the second alignment layer provides a horizontal liquid crystal molecule orientation such that a longitudinal axis of the liquid crystal molecule is pre-tilted 0°-4° against the second alignment layer.

Since the different alignment interfaces between regions I and II cause a disclination line between boundary region 370, when the OCB-LCD device is driven by appropriate procedure, liquid crystal molecules 360a and 360b adjacent to the disclination line become nucleation sites of splay-to-bend transition, thereby accelerating phase transition speed and increasing viewing angles due to multiple aligned domains.

FIG. 6B is a cross section of a second embodiment of a multiple aligned domain OCB-LCD device of the invention. Referring to FIG. 6B, the OCB-LCD device 300b is nearly identical to the OCB-LCD device 300a of the first embodiment (as shown in FIG. 6A) and for simplicity detailed descriptions are omitted. The second embodiment is different from the first embodiment in that a first alignment layer 340, such as commercial model SE-7492, is entirely applied on the first substrate 310. A hard bake process and a rubbing process are sequentially performed on the first substrate 310. A second alignment layer 350′ is selectively disposed on a second region II of the first alignment layer 340, exposing a first region I of the first alignment layer 340. For example, the second alignment layer 350′, such as γ-butylactone, is inkjet printed on a peripheral region of the first alignment layer (e.g., SE-7492). A baking process is performed such that orientations of liquid crystal molecules on the first region I and on the second region II are different. Alternatively, a baking process and rubbing process are sequentially performed such that orientations of liquid crystal molecules on the first region I and on the second region II are different. The first alignment layer 340 and the second alignment 350′ separately provide the liquid crystal layer with different alignments and pre-tilt angles (as indicated as angle B and angle C). Angle B can be the same as or different from angle C. According to an exemplary embodiment of the invention, the second alignment layer comprises an organic solvent, such as ethanol, isopropanol, n-methyl pyrrolidone, m-cresol, γ-butylactone, n,n-dimethylacetamide, n,n-dimethylformamide, ethylene glycol monobutyl ether, or diethylene glycol monoethyl ether.

FIG. 6C is a cross section of a third embodiment of a multiple aligned domain OCB-LCD device of the invention. Referring to FIG. 6C, the OCB-LCD device 300c is nearly identical to the OCB-LCD device 300a of the first embodiment (as shown in FIG. 6A) and for simplicity detailed descriptions are omitted. The third embodiment is different from the first embodiment in that a third alignment layer 330, such as commercial model SE-7492, is selectively applied on a second region II of the second substrate 320. A hard bake process is then performed on the second substrate 320. A fourth alignment layer 335 is selectively disposed on a first region I of the second substrate 320. For example, the fourth alignment layer 335, such as commercial model SE-1410 diluted by γ-butylactone, is inkjet printed on a peripheral region of the third alignment layer (e.g., SE-7492). A baking process is performed such that orientations of liquid crystal molecules on the first region I and on the second region II are different. Alternatively, a baking process and rubbing process are sequentially performed such that orientations of liquid crystal molecules on the first region I and on the second region II are different. The third alignment layer 330 and the fourth alignment 335 separately provide the liquid crystal layer with different alignments and pre-tilt angles (as indicated as angle A and angle D). Angle A can be the same as or different from angle D. According to an exemplary embodiment of the invention, the third alignment layer 330 and the fourth alignment layer 335 can be respectively formed on the first region I and the second region II of the second substrate 320 by printing or inkjet printing.

FIG. 6D is a cross section of a fourth embodiment of a multiple aligned domain OCB-LCD device of the invention. Referring to FIG. 6D, the OCB-LCD device 300d is nearly identical to the OCB-LCD device 300b of the second embodiment (as shown in FIG. 6B) and for simplicity detailed descriptions are omitted. The fourth embodiment is different from the second embodiment in that a third alignment layer 330, such as commercial model SE-7492, is selectively applied on a second region II of the second substrate 320. A hard bake process is then performed on the second substrate 320. A fourth alignment layer 335 is selectively disposed on a first region I of the second substrate 320. For example, the fourth alignment layer 335, such as commercial model SE-1410 diluted by γ-butylactone, is inkjet printed on a peripheral region of the third alignment layer (e.g., SE-7492). A baking process and rubbing process are sequentially performed such that orientations of liquid crystal molecules on the first region I and on the second region II are different. The third alignment layer 330 and the fourth alignment 335 separately provide the liquid crystal layer with different alignments and pre-tilt angles (as indicated as angle A and angle D). Angle A can be the same as or different from angle D. According to an exemplary embodiment of the invention, the third alignment layer 330 and the fourth alignment layer 335 can be respectively formed on the first region I and the second region II of the second substrate 320 by printing and inkjet printing.

FIG. 6E is a cross section of a fifth embodiment of a multiple aligned domain OCB-LCD device of the invention. Referring to FIG. 6E, the OCB-LCD device 300e is nearly identical to the OCB-LCD device 300b of the second embodiment (as shown in FIG. 6B) and for simplicity detailed description are omitted. The fifth embodiment is different from the second embodiment in that a third alignment layer 330, such as commercial model SE-7492, is entirely applied on the second substrate 320. A hard bake process and a rubbing process are sequentially performed on the second alignment layer 330. A fourth alignment layer 335′ is selectively disposed on a first region I of the second alignment layer 330. For example, the fourth alignment layer 335′, such as γ-butylactone, is inkjet printed on a peripheral region of the third alignment layer 330 (e.g., SE-7492). A baking process is performed such that orientations of liquid crystal molecules on the first region I and on the second region II are different. Therefore, the third alignment layer 330 and the fourth alignment 335′ separately provide the liquid crystal layer with different alignments and pre-tilt angles (as indicated as angle A and angle D). Angle A can be the same as or different from angle D.

The invention is advantageous in that different pre-tilt angles and/or multiple aligned domain regions of OCB-LCD devices can be achieved by multiply applying different alignment layers on different regions. Optically compensated bend (OCB) mode liquid crystal material is less affected by liquid crystal liquidity and splay-to-bend transition of liquid crystal molecules is shortened due to high per-tilt angles, resulting in faster response speed, accelerating phase transition speed and increasing viewing angles due to multiple aligned domains Moreover, different alignment materials can be applied by different methods including relief (or anastatic) printing and inkjet printing at different regions, thereby improving viewing angle, brightness, contrast ratio, and aperture of the LCD device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optically compensated bend (OCB) mode liquid crystal display device, comprising:
a first substrate opposite a second substrate with a layer of liquid crystal molecules interposed therebetween;
a first alignment layer disposed on the first substrate;
a second alignment layer selectively disposed on a second region of the first alignment layer, exposing a first region of the first alignment layer; and
a third alignment layer disposed on the second substrate;
wherein orientations of liquid crystal molecules on the first alignment layer and on the second alignment layer are different, and
wherein when a voltage is applied to the OCB mode liquid crystal display device, a dual mode transition boundary is created between the first region and the second region.

2. The OCB mode liquid crystal display device as claimed in claim 1, wherein the dual mode transition boundary is a splay-to-bend mode transition boundary.

3. The OCB mode liquid crystal display device as claimed in claim 1, wherein the first substrate is an active matrix array substrate.

4. The OCB mode liquid crystal display device as claimed in claim 1, wherein the first substrate is a color filter substrate.

5. The OCB mode liquid crystal display device as claimed in claim 4, wherein the color filter substrate comprises:
a plurality of color filter structures disposed on the color filter substrate; and
a black matrix disposed among the plurality of color filter structures.

6. The OCB mode liquid crystal display device as claimed in claim 5, further comprising an electrode structure disposed on the color filter structure, and wherein the first alignment layer is disposed on the electrode structure.

7. The OCB mode liquid crystal display device as claimed in claim 1, wherein the first region is a pixel region, and the second region is a peripheral region.

8. The OCB mode liquid crystal display device as claimed in claim 1, wherein the first region is a peripheral region, and the second region is a pixel region.

9. The OCB mode liquid crystal display device as claimed in claim 8, wherein the peripheral region comprises a black matrix region, a gate line region, a data line region, an active device region, a contact hole region, and a slit region.

10. The OCB mode liquid crystal display device as claimed in claim 1, wherein the first region is a portion of a pixel region, and the second region is another portion of the pixel region.

11. The OCB mode liquid crystal display device as claimed in claim 1, wherein the first alignment layer provides a vertical liquid crystal molecule orientation such that a longitudinal axis of the liquid crystal molecule is pre-tilted 75°-90° against the first alignment layer; and wherein the second alignment layer provides a horizontal liquid crystal molecule orientation such that a longitudinal axis of the liquid crystal molecule is pre-tilted 0°-15° against the second alignment layer.

12. The OCB mode liquid crystal display device as claimed in claim 1, wherein the first alignment layer provides a horizontal liquid crystal molecule orientation such that a longitudinal axis of the liquid crystal molecule is pre-tilted 0°-10° against the first alignment layer; and wherein the second alignment layer provides a horizontal liquid crystal molecule orientation such that a longitudinal axis of the liquid crystal molecule is pre-tilted 0°-9° against the second alignment layer.

13. The OCB mode liquid crystal display device as claimed in claim 1, wherein the first alignment layer provides a horizontal liquid crystal molecule orientation such that a longitudinal axis of the liquid crystal molecule is pre-tilted 0°-7° against the first alignment layer; and wherein the second alignment layer provides a horizontal liquid crystal molecule orientation such that a longitudinal axis of the liquid crystal molecule is pre-tilted 0°-4° against the second alignment layer.

14. The OCB mode liquid crystal display device as claimed in claim 1, wherein the first alignment layer comprises polyvinyl alcohol (PVA), polyimide (PI), polyamide (PA), polyurethane (PU), nylon, silicon, or lecithin.

15. The OCB mode liquid crystal display device as claimed in claim 1, wherein the second alignment layer comprises polyvinyl alcohol (PVA), polyimide (PI), polyamide (PA), polyurethane (PU), nylon, silicon, or lecithin.

16. The OCB mode liquid crystal display device as claimed in claim 1, wherein the third alignment layer comprises polyvinyl alcohol (PVA), polyimide (PI), polyamide (PA), polyurethane (PU), nylon, silicon, or lecithin.

17. The OCB mode liquid crystal display device as claimed in claim 1, wherein the second alignment layer comprises an organic solvent.

18. The OCB mode liquid crystal display device as claimed in claim 17, wherein the organic solvent comprises ethanol, isopropanol, n-methyl pyrrolidone, m-cresol, γ-butylactone, n,n-dimethylacetamide, n,n-dimethylformamide, ethylene glycol monobutyl ether, or diethylene glycol monoethyl ether.

19. An optically compensated bend (OCB) mode liquid crystal display device, comprising:
a first substrate opposite a second substrate with a layer of liquid crystal molecules interposed therebetween;
a first alignment layer disposed on the first substrate;
a second alignment layer selectively disposed on a second region of the first alignment layer, exposing a first region of the first alignment layer;
a third alignment layer disposed on the second substrate; and
a fourth alignment layer selectively disposed on a second region of the third alignment layer, exposing a first region of the third alignment layer;
wherein orientations of liquid crystal molecules on the first alignment layer and on the second alignment layer are different, and orientations of liquid crystal molecules on the third alignment layer and on the fourth alignment layer are different, and
wherein when a voltage is applied to the OCB mode liquid crystal display device, a dual mode transition boundary is created between the first region and the second region.

20. The OCB mode liquid crystal display device as claimed in claim 19, wherein the dual mode transition boundary is a splay-to-bend mode transition boundary.

21. The OCB mode liquid crystal display device as claimed in claim 19, wherein the first substrate is an active matrix array substrate.

22. The OCB mode liquid crystal display device as claimed in claim 19,
wherein the first substrate is a color filter substrate.

23. The OCB mode liquid crystal display device as claimed in claim 22, wherein the color filter substrate comprises:
a plurality of color filter structures disposed on the color filter substrate; and
a black matrix disposed among the plurality of color filter structures.

24. The OCB mode liquid crystal display device as claimed in claim 23, further comprising an electrode structure disposed on the color filter structure, and wherein the first alignment layer is disposed on the electrode structure.

25. The OCB mode liquid crystal display device as claimed in claim 19, wherein the first region is a pixel region, and the second region is a peripheral region.

26. The OCB mode liquid crystal display device as claimed in claim 19, wherein the first region is a peripheral region, and the second region is a pixel region.

27. The OCB mode liquid crystal display device as claimed in claim 26, wherein the peripheral region comprises a black matrix region, a gate line region, a data line region, an active device region, a contact hole region, and a slit region.

28. The OCB mode liquid crystal display device as claimed in claim 19, wherein the first region is a portion of a pixel region, and the second region is another portion of the pixel region.

29. The OCB mode liquid crystal display device as claimed in claim 19, wherein the first alignment layer provides a vertical liquid crystal molecule orientation such that a longitudinal axis of the liquid crystal molecule is pre-tilted 75°-90° against the first alignment layer; and wherein the second alignment layer provides a horizontal liquid crystal molecule orientation such that a longitudinal axis of the liquid crystal molecule is pre-tilted 0°-15° against the second alignment layer.

30. The OCB mode liquid crystal display device as claimed in claim 19, wherein the first alignment layer provides a horizontal liquid crystal molecule orientation such that a longitudinal axis of the liquid crystal molecule is pre-tilted 0°-10° against the first alignment layer; and wherein the second alignment layer provides a horizontal liquid crystal molecule orientation such that a longitudinal axis of the liquid crystal molecule is pre-tilted 0°-9° against the second alignment layer.

31. The OCB mode liquid crystal display device as claimed in claim 19, wherein the first alignment layer provides a horizontal liquid crystal molecule orientation such that a longitudinal axis of the liquid crystal molecule is pre-tilted 0°-7° against the first alignment layer; and wherein the second alignment layer provides a horizontal liquid crystal molecule orientation such that a longitudinal axis of the liquid crystal molecule is pre-tilted 0°-4° against the second alignment layer.

32. The OCB mode liquid crystal display device as claimed in claim 19, wherein the first alignment layer comprises polyvinyl alcohol (PVA), polyimide (PI), polyamide (PA), polyurethane (PU), nylon, silicon, or lecithin.

33. The OCB mode liquid crystal display device as claimed in claim 19, wherein the second alignment layer comprises polyvinyl alcohol (PVA), polyimide (PI), polyamide (PA), polyurethane (PU), nylon, silicon, or lecithin.

34. The OCB mode liquid crystal display device as claimed in claim 19, wherein the third alignment layer comprises polyvinyl alcohol (PVA), polyimide (PI), polyamide (PA), polyurethane (PU), nylon, silicon, or lecithin.

35. The OCB mode liquid crystal display device as claimed in claim 19, wherein the fourth alignment layer comprises polyvinyl alcohol (PVA), polyimide (PI), polyamide (PA), polyurethane (PU), nylon, silicon, or lecithin.

36. The OCB mode liquid crystal display device as claimed in claim 19, wherein the second alignment layer comprises an organic solvent.

37. The OCB mode liquid crystal display device as claimed in claim 36, wherein the organic solvent comprises ethanol, isopropanol, n-methyl pyrrolidone, m-cresol, γ-butylactone, n,n-dimethylacetamide, n,n-dimethylformamide, ethylene glycol monobutyl ether, or diethylene glycol monoethyl ether.

38. A method for fabricating an optically compensated bend (OCB) mode liquid crystal display device, comprising:
providing a first substrate with an electrode structure thereon;
applying a first alignment layer on the first substrate;
printing a second alignment layer on the second region of the first alignment layer, exposing a first region of the first alignment layer;
applying a third alignment layer on a second substrate;
opposite assembling the first substrate and the second substrate; and
injecting a layer of liquid crystal molecules between the first substrate and the second substrate;
wherein orientations of liquid crystal molecules on the first alignment layer and on the second alignment layer are different, and
wherein when a voltage is applied to the OCB mode liquid crystal display device, a dual mode transition boundary is created between the first region and the second region.

39. The method as claimed in claim 38, wherein the dual mode transition boundary is a splay-to-bend mode transition boundary.

40. The method as claimed in claim 38, wherein applying the first alignment on the first substrate comprises rolling, spin coating, spraying, or inkjet printing.

41. The method as claimed in claim 38, after applying the first alignment layer on the first substrate, further comprising performing a soft bake procedure on the first substrate.

42. The method as claimed in claim 38, after applying the first alignment layer on the first substrate, further comprising performing a soft bake and a hard bake procedures on the first substrate.

43. The method as claimed in claim 38, wherein printing the second alignment on the second region of the first alignment layer comprises screen printing, spraying, or inkjet printing.

44. The method as claimed in claim 38, after printing the second alignment on the second region of the first alignment layer, further comprising performing a soft bake and a hard bake procedures on the first substrate.

45. The method as claimed in claim 38, wherein the first region is a pixel region, and the second region is a peripheral region.

46. The method as claimed in claim 38, wherein the first region is a peripheral region, and the second region is a pixel region.

47. The method as claimed in claim 46, wherein the peripheral region comprises a black matrix region, a gate line region, a data line region, an active device region, a contact hole region, and a slit region.

48. The method as claimed in claim 38, wherein the first region is a portion of a pixel region, and the second region is another portion of the pixel region.

49. The method as claimed in claim 38, wherein the first alignment layer provides a vertical liquid crystal molecule orientation such that a longitudinal axis of the liquid crystal molecule is pre-tilted 75°-90° against the first alignment layer; and wherein the second alignment layer provides a horizontal liquid crystal molecule orientation such that a longitudinal axis of the liquid crystal molecule is pre-tilted 0°-15° against the second alignment layer.

50. The method as claimed in claim 38, wherein the first alignment layer provides a horizontal liquid crystal molecule orientation such that a longitudinal axis of the liquid crystal molecule is pre-tilted 0°-10° against the first alignment layer; and wherein the second alignment layer provides a horizontal liquid crystal molecule orientation such that a longitudinal axis of the liquid crystal molecule is pre-tilted 0°-9° against the second alignment layer.

51. The method as claimed in claim 38, wherein the first alignment layer provides a horizontal liquid crystal molecule orientation such that a longitudinal axis of the liquid crystal molecule is pre-tilted 0°-7° against the first alignment layer; and wherein the second alignment layer provides a horizontal liquid crystal molecule orientation such that a longitudinal axis of the liquid crystal molecule is pre-tilted 0°-4° against the second alignment layer.

52. The method as claimed in claim 38, wherein the first alignment layer comprises polyvinyl alcohol (PVA), polyimide (PI), polyamide (PA), polyurethane (PU), nylon, silicon, or lecithin.

53. The method as claimed in claim 38, wherein the second alignment layer comprises polyvinyl alcohol (PVA), polyimide (PI), polyamide (PA), polyurethane (PU), nylon, silicon, or lecithin.

54. The method as claimed in claim 38, wherein the third alignment layer comprises polyvinyl alcohol (PVA), polyimide (PI), polyamide (PA), polyurethane (PU), nylon, silicon, or lecithin.

55. The method as claimed in claim 38, wherein the second alignment layer comprises an organic solvent.

56. The method as claimed in claim 55, wherein the organic solvent comprises ethanol, isopropanol, n-methyl pyrrolidone, m-cresol, γ-butylactone n,n-dimethylacetamide, n,n-dimethylformamide, ethylene glycol monobutyl ether, or diethylene glycol monoethyl ether.

57. The method as claimed in claim 38, further comprising printing a fourth alignment layer on the second region of the third alignment layer, exposing a first region of the third alignment layer.
